(19) United States
(12) Patent Application Publication
(10) Pub. No.: US 2020/0041088 A1
(43) Pub. Date: Feb. 6, 2020

(54) ILLUMINATING DEVICE FOR A MOTOR VEHICLE, PARTICULARLY A HEADLIGHT FOR A MOTOR VEHICLE

(71) Applicant: Hella GmbH & Co. KGaA, Lippstadt (DE)

(72) Inventors: Björn Dreßler, Menden (DE); Waldemar Petker, Bünde (DE)

(21) Appl. No.: 16/340,284

(22) PCT Filed: Oct. 5, 2017
(86) PCT No.: PCT/EP2017/075390

§ 371 Date: Apr. 8, 2019

(30) Foreign Application Priority Data
Oct. 11, 2016 (DE) 10 2016 119 321.6

(51) Int. Cl. F21S 41/24; F21S 41/143; F21S 41/663

(52) U.S. Cl. CPC F21S 41/24; F21Y 2115/10; F21S 41/663; F21S 41/143

(57) ABSTRACT

An illuminating device for a motor vehicle, in particular a headlight for a motor vehicle, which includes at least one initial light source which sends out light when the illuminating device is operated. The illuminating device further includes an initial optical device, which has at least one light receiving surface for the light emitted from at least one initial light source, and has at least one light emitting surface. The illuminating device further includes a second optical device. The second optical device has a structuring on the side facing away from the initial optical device at least in sections.

### CROSS REFERENCE

This application claims priority to PCT Application No. PCT/EP2017/075390, filed Oct. 5, 2017, which itself claims priority to German Patent Application 10 2016 118321.6, filed Oct. 11, 2016, the entirety of both of which are hereby incorporated by reference.

### FIELD OF THE INVENTION

This invention consists of an illuminating device for a motor vehicle, particularly a headlight of a motor vehicle.

### BACKGROUND

Illuminating devices of the aforementioned type are known and are designed for example as a headlight. As an example, this could consist of an initial light source and an initial optical device used to generate a low beam and a second light source and a second optical device used to generate a high beam. An example design of a headlight in accordance with the state of the art is shown in FIG. 4.

This headlight contains an initial optical device 1 with a light emitting surface 2 and a second optical device 3 with a light emitting surface 4 where the light emitting surface 2 of the initial optical device 1 is positioned above the second optical device 2. The headlight furthermore contains a lens 5 through which the light emitted from both emitting areas 2, 4 passes at least partially and then is emitted in a frontal direction from the headlight.

FIG. 4 shows that a portion 6 of the light emitted from the light emitting surface 2 can enter into a subarea 7 of the second optical device 3. This subarea 7 is shown to be comparatively flat in the example design, and can be used as a light guide for the entering light 6. The light 6 experiences multiple total reflections in the subarea 7, and likewise is emitted from the emitting area 4 of the second optical device 3 in such a way that it can likewise be emitted in a frontal direction from the headlight. In this way, the light 6 incoupled from above in the subarea 7 of the second optical device 3 can cause unwanted light effects, for example a glare.

A further example design of a headlight in accordance with the state of the art is shown in FIG. 5. In this example design, the same parts are labeled with the same reference numbers as in FIG. 4.

In contrast to FIG. 4, the subarea 7 serving as a light guide for the second optical device 3 has a reflective damping 8 on its upper side, from which the disruptive portion of the light 6 is reflected upward onto the lens 5. This effectively avoids the unwanted light effects. However, the fact that this damping on the surface of the light guide means there is an additional process step when manufacturing the headlight which involves high costs and great effort must be viewed here as a disadvantage. The fact that the damping can tear over the course of its service life and could become loose from the upper side of the subarea 7 of the second optical device 3 is also to be seen as an additional disadvantage.

### SUMMARY OF THE INVENTION

The problem that this invention solves is the creation of an illuminating device of the type described at the beginning of this document which can prevent or reduce unwanted light effects at comparatively low cost and effort.

It is intended that the second optical device have structuring on the side in front of the initial optical device at least in sections. As such, the structuring is designed such that the light from the light emitting surface of the initial optical device and the light which enters the area of the structuring is at least partially emitted from the second optical device. As a result of this structuring, unwanted light which has entered the second optical device from the initial optical device can be at least partially outcoupled from the second optical device without it reaching the emitting area and causing the conventional unwanted light effects from the prior art, such as, for example, glare.

The structure can be ribbed. Preferably, the structuring can have a multitude of ribs that are set at a distance from one another, particularly a multitude of ribs that are equidistant to one another. A design of this type is effective and easy to manufacture. For example, expensive and complicated damping on the upper side of the light guide can be omitted. Furthermore, the rib structure is not subjected over its service life to any of the conventional aging effects experienced by the prior art, such as chipping on the damping on the upper side of the second optical device.

There is an option for the second optical device to be more extended than the initial optical device in the direction of propagation of the light, where particularly the structuring is arranged at least partially in the section of the second optical device, which projects beyond the initial optical device in the direction of propagation of the light. This means that wherever the portions of the light emitted from the initial optical device can make unwanted entry into the second optical device, the structuring ensures at least a partial outcoupling of these light portions from the second optical device such that the unwanted light effects are able to be effectively prevented or reduced.

The initial and/or the second optical device can be designed as a light guide. Due to the structuring and, with it, the outcoupling of the unwanted light portions from the second optical device, the design of the second optical device does not result in emission of the unwanted light portions from at least one of the emitting areas.

There is the option that the initial and/or the second light source be designed as a light emitting diode or includes at least one light emitting diode. This means that the illuminating device can be designed compactly.

It can be the case that the illuminating device includes at least one second light source which emits light when the illuminating device is operated, where the second optical device has at least one light receiving surface for the light from at least one second light source and at least one light emitting surface.

As such, the initial light source and the initial optical device can be used to generate a low beam or a partial function of a low beam and/or the second light source and the second optical device can be used to generate a high beam. There is also the option that the initial light source and the initial optical device alternatively or additionally can enable other light functions.

Furthermore, it can be the case that the illuminating device includes a lens through which the light emitted from at least one light emitting surface of the initial and/or second optical device goes through when the illuminating device is operated. This results in a particularly effectively designed headlight for a motor vehicle.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic view of the second optical device of an illuminating device in line with the invention.

FIG. 2 shows a schematic cross-section through the initial and the second optical device of the illuminating device in accordance with FIG. 1.

FIG. 3 shows a view in accordance with FIG. 2 of the illuminating device with a beam path of a light portion which is entering the second optical device from the initial optical device.

FIG. 4 is a cross-section through an initial design type of an illuminating device in accordance with the state of the art.

FIG. 5 is a cross-section through a second design type of an illuminating device in accordance with the state of the art.

### DETAILED DESCRIPTION OF THE DRAWINGS

In the figures, identical components and components with identical functions have been given the same reference numbers.

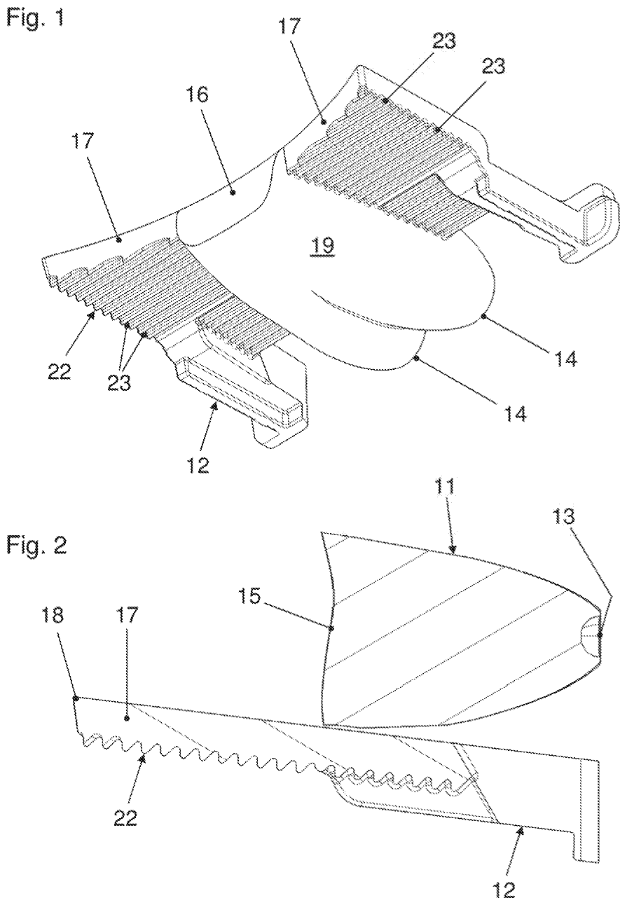

The design type shown in FIG. 1 through FIG. 3 of an illuminating device in accordance with the invention is designed as a headlight on a motor vehicle. The design type includes at least one initial light source designed as a light emitting diode (LED) (not pictured) and at least one second light source designed as a light emitting diode (not pictured). In doing so, at least one initial light source is used to generate a low beam and at least one second light source is used to generate a high beam.

There is the option to use other light sources instead of the light emitting diodes. For example, semiconductor lasers can also be used as light sources.

The light sources can be controlled separately in order to switch between the low beam and the high beam. There is also the option to realize other functions of an adaptive front lighting system through various current flows to the light sources, such as city light, country light or freeway light. There is also the option to switch to a mono function.

The headlight design type pictured furthermore includes the initial optical device 11 designed as light guide equipment for the low beam and the second optical device 12 designed as light guide equipment for the high beam (see FIG. 2 for an example). The optical devices 11, 12 can be made of glass or plastic, for example from PC or PMMA.

On their right side in FIG. 1 and FIG. 2, the optical devices 11, 12 have at least one light receiving surface 13, 14 onto which the light from the light emitting diodes is incoupled when the headlight is operated. FIG. 1 makes clear that the second optical device 12 has two light receiving surfaces 14. The initial optical device 11 can also have two light receiving surfaces 13 as an example.

However, there is the option to arrange more or fewer light receiving surfaces 13, 14 on both the initial optical device 11 and on the second optical device 12.

It can be the case that, in front of each of the light receiving surfaces 13, 14, respectively, there is a light source, for example designed as a light emitting diode. There is however also the option, particularly due to the shape and size of the light receiving surfaces 13, 14, to have more than one light source designed for example as a light emitting diode arranged in front of each of the light receiving surfaces 13, 14 so that correspondingly more light sources can be provided for the high beams and/or the low beams.

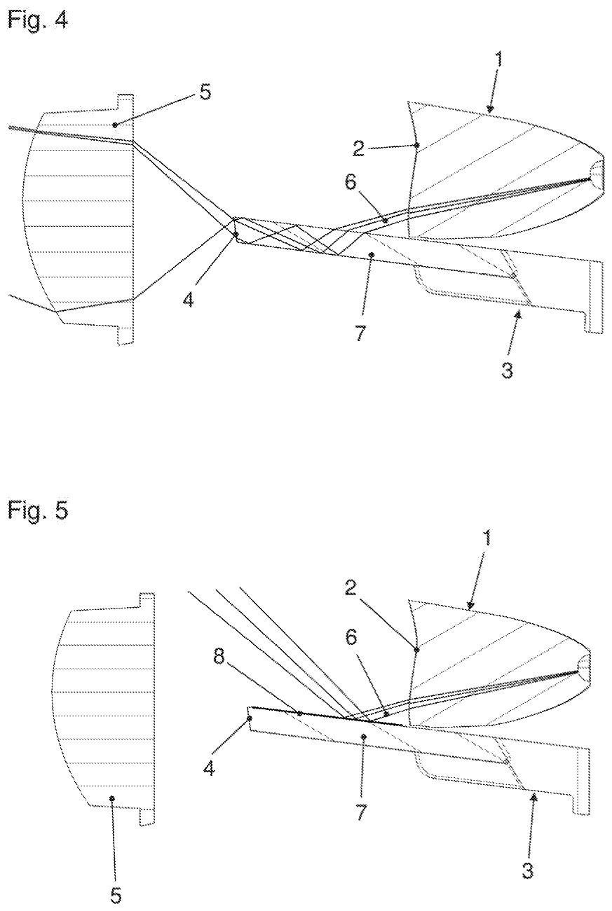

On their left side in FIG. 1 and FIG. 2, the optical device 11, 12 each have a light emitting surface 15, 16 which emits the light. The design type shown of a headlight in accordance with the invention furthermore includes a lens (not pictured) which is arranged in the propagation direction of the light behind the light emitting surfaces 15, 16 of the optical device 11, 12 (see for example the state of the art in FIG. 4 and FIG. 5 and the lens 5 there). The lens can be designed as a plano-convex lens. There is certainly also the option for the lens to have other designs.

The initial optical device 11 is shorter in the direction of propagation than the second optical device 12 (see for example FIG. 2), such that the light emitted from the light emitting surface 15 of the initial optical device 11 is emitted above the second optical device 12.

FIG. 1 shows that the light emitting surface 16 of the second optical device 12 is concave. This achieves a correction of the field of curvature for the high beam. The second optical device 12 furthermore has a low thickness and a front, upper edge 18 on the sides of the subarea 17 of the light emitting surface 16. This front, upper edge 18 defines the cut-off line for the low beam, which is emitted from the light emitting surface 15 of the initial optical device 11.

Between the subareas 17, there is a middle area 19 of the second optical device 12 extending from at least one light receiving surface 14 to at least one light emitting surface 16 which projects downward in relation to the subareas 17 (see FIG. 1). The light that is used for the high beams which has been generated by at least one second light source and enters at least a light receiving surface 14 passes only through this middle area 19 of the second optical device 12.

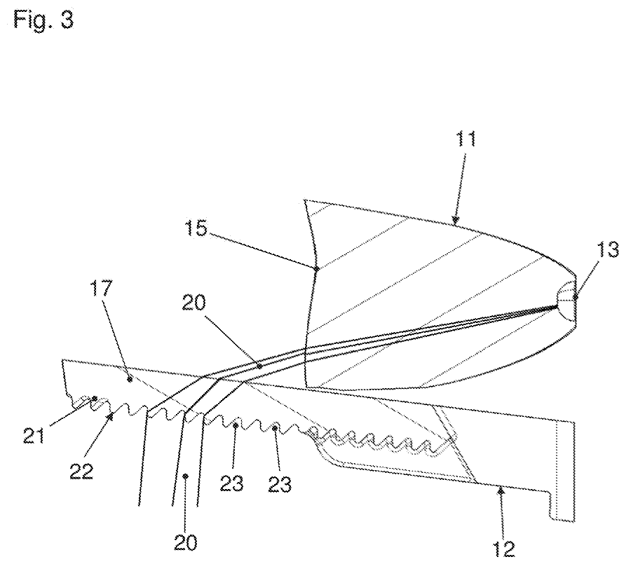

FIG. 3 makes it clear that a portion 20 of the light from the emitting surface 15 of the initial optical device 11 is aligned downward at such an angle that it enters the into the second optical device 12, particularly in the subareas 17 arranged to the sides of the emitting area 16, from above. In the subareas 17, the portion 20 of the light goes downward at an angle and lands there on the side 21 facing away from the initial optical device 11 of the subareas 17 (see FIG. 3).

This side 21 of the subareas 17 facing away from the initial optical device 11 has a structuring 22 which is particularly formed as ribbing with a multitude of ribs 23. The ribs 23 extend in the lateral direction of the second optical device 12 and in a direction at a right angle to the direction between at least one light receiving surface 14 and at least one light receiving surface 16 (see also FIG. 1). The ribs 23 are set at a distance from one another, particularly equidistant to one another.

If the portion 20 of the light emitted downward at an angle from the initial optical device 11 in the subareas 17 reaches the side 21 with the structuring 22, then a portion, including the light hitting the inner side of the ribs 23, particularly a large part of the portion 20 from the second optical device 12, will be outcoupled due to the angle. The portion 20 of light outcoupled in this way can therefore not be emitted forward from the subareas 17 or the emitting area 16 such that unwanted light effects such as glare for oncoming traffic when operating the low beams is mostly prevented.

FIG. 1 shows that, in the example design shown, the subareas 17 are comparatively completely provided with the structuring 22, while the middle area 19 does not have any corresponding structuring, designed for example as ribbing. There is however certainly the option to provide a structuring even in the middle area, at least in sections. Furthermore, just single or multiple sections of the subareas 17 can be provided with a structuring, while individual or multiple other sections of the subareas 17 have no structuring.

Furthermore, there is the option to provide it with a different structuring other than ribbing that is suitable to outcouple at least a part of the portion 20 of light that has entered the second optical device 12 from the initial optical device 11 downward or onto the side 21 facing away from the initial optical device 11 from the second optical device 12.

### REFERENCE NUMERAL LIST

1 Initial optical device
2 Light emitting area of the initial optical device 1
3 Second optical device
4 Light emitting area of the second optical device 3
5 Lens
6 Portion of the light emitted from the light emitting surface 2
7 Partial area of the second optical device 3
8 Reflective damping on the subarea 7
11 Initial optical device
12 Second optical device
13 Light receiving area of the initial optical device 11
14 Light receiving area of the second optical device 12
15 Light emitting area of the initial optical device 11
16 Light emitting area of the second optical device 12
17 Partial area of the second optical device 12
18 Front upper edge of the subarea 17
19 Middle area of the second optical device 12
20 Portion of the light emitted from the light emitting surface 15
21 Side of the subarea 17 facing away from the initial optical device 11
22 Structuring on the side 21
23 Rib of the structuring 22

1. An illuminating device for a motor vehicle comprising:
one or more light sources; that emit light when the illuminating device is operated,
an initial optical device that has at least one light receiving surface that receives light originating from at least one of said one or more light sources, said initial optical device including one or more light emitting surfaces (15),
a second optical device wherein the second optical device has a structuring on the side facing away from the initial optical device at least in sections.

2. The illuminating device according to claim 1, wherein light from the light emitting surface of the initial optical device and the light which enters the area of the structuring is at least partially emitted from the second optical device.

3. The illuminating device according to claim 1, wherein the structuring is ribbed.

4. The illuminating device according to claim 1, wherein the structuring has a multitude of ribs that are equidistant to one another.

5. The illuminating device in accordance with claim 1, wherein the second optical device is more extended than the initial optical device in the direction of propagation of the light, where the structuring is arranged at least partially in the section of the second optical device, which projects the initial optical device in the direction of propagation of the light.

6. The illuminating device in accordance with claim 1, wherein the initial and/or the second optical device is designed as a means of guiding the light.

7. The illuminating device in accordance with claim 1, wherein the initial and/or the second optical light source is designed as a light emitting diode or includes at least one light emitting diode.

8. The illuminating device in accordance with claim 1, wherein the illuminating device includes at least a second light source, where the second optical device has at least one light receiving surface for the light from at least one second light source and at least one light emitting surface.

9. The illuminating device in accordance with claim 8, wherein the initial light source and the initial optical device is used to generate a low beam or a partial function of a low beam and/or in that the second light source and the second optical device is used to generate a high beam.

10. The illuminating device in accordance with claim 1, wherein the illuminating device includes a lens through which the light being emitted from at least one light emitting surface when the illuminating device apparatus is operated passes through the initial and/or the second optical device.
